(19) United States
(12) Patent Application Publication
(10) Pub. No.: US 2024/0168459 A1
(43) Pub. Date: May 23, 2024

(54) SYSTEM AND METHOD OF NON-PLANAR SLICING AND PRINTING USING ADDITIVE MANUFACTURING

(71) Applicant: SprintRay, Inc., Los Angeles (CA)

(72) Inventors: Amir Mansouri, Los Angeles, CA (US); Huijian Tian, Los Angeles, CA (US)

(21) Appl. No.: 18/514,484

(22) Filed: Nov. 20, 2023

Related U.S. Application Data
(60) Provisional application No. 63/426,534, filed on Nov. 18, 2022.

(51) Int. Cl. G05B 19/4099

(52) U.S. Cl. CPC G05B 19/4099; G05B 2219/49023

(57) ABSTRACT

A system and method of non-planar slicing and three-dimensional (3D) printing of objects with at least one overhang structure. The system includes slicing software that performs non-planar slicing of the object's corresponding digital file, and control software that tilts the 3D printer's build platform during the printing of the overhang structure in accordance with the non-planar slicing information.

### FIELD OF THE INVENTION

This application claims priority to U.S. Provisional Application No. 63/426,534, filed on Nov. 18, 2022, the disclosure of which is incorporated by reference in its entirety.

### PRIORITY AND RELATED APPLICATIONS

This invention relates to additive manufacturing, including a system and method of non-planar slicing and printing using additive manufacturing.

### BACKGROUND

With conventional three-dimensional printing systems, when an object being 3D printed includes an overhang structure at an angle of inclination greater than a predetermined criteria angle, the overhang structure may require the addition of 3D printed support structures to be successfully printed. The support structures are added by the printing software (e.g., by the slicing software) and may typically extend from the overhang structure to the build platform thereby providing the overhang with added vertical support. In this way, the overhang structure may not droop or otherwise become deformed during the 3D printing process. Once the printing process is completed and the object is removed from the build platform, the support structures may be removed from the object (e.g., by cutting).

However, such support structures increase the amount of resin used to print the object thereby increasing its overall cost. In addition, removal of the support structures from the object oftentimes leaves surface marks on the object that may or may not be removed via polishing.

Accordingly, there is a need for a system and method of non-planar slicing and printing to minimize the need for overhang support structures.

### SUMMARY

According to one aspect, one or more embodiments are provided below for a system and method of non-planar slicing and printing using additive manufacturing.

According to one aspect, a method of three-dimensional (3D) printing an object on a build platform, the object including an overhang structure, comprises receiving a digital file including a representation of the object including a representation of the overhang structure, determining, by one or more computer systems, an angle of inclination of the representation of the overhang structure, determining a build platform tilt angle to reduce the angle of inclination to below an overhang angle threshold, tilting the build platform to the build platform tilt angle, and 3D printing the overhang structure.

In another embodiment, the method comprises slicing, by one or more computer systems, the representation of the overhang structure.

In another embodiment, the slicing of the representation of the overhang structure includes non-planar slicing.

In another embodiment, the object includes a vertical portion and the overhang structure, and the method further comprises slicing, by one or more computer systems, a representation of the vertical portion within the digital file and the representation of the overhang structure, wherein the slicing of the representation of the overhang structure includes non-planar slicing with respect to the slicing of the representation of the vertical portion.

In another embodiment, an angle of the non-planar slicing is based at least in part on the angle of inclination of the representation of the overhang structure.

In another embodiment, an absolute value of the angle of the non-planar slicing is substantially equal to an absolute value of the angle of inclination of the representation of the overhang structure.

In another embodiment, the build platform tilt angle is based at least in part on the angle of inclination of the representation of the overhang structure.

In another embodiment, an absolute value of the build platform tilt angle is substantially equal to an absolute value of angle of the inclination of the representation of the overhang structure.

According to another aspect, a method of three-dimensional (3D) printing an object on a build platform, the object including a vertical portion with an overhang structure, comprises receiving a digital file including a representation of the object including a representation of the vertical portion and of the overhang structure, determining, by one or more computer systems, an angle of inclination of the representation of the overhang structure, determining, by one or more computer systems, if the angle of inclination of the representation of the overhang structure is greater than an overhang angle threshold, in response to a determination that the representation of the overhang structure is greater than the overhang angle threshold, then, determining a build platform tilt angle to reduce the angle of inclination of the overhang structure to below the overhang angle threshold, 3D printing the vertical portion, tilting the build platform to the build platform tilt angle, and 3D printing the overhang structure.

In another embodiment, the method comprises slicing, by one or more computer systems, the representation of the vertical portion and the representation of the overhang structure, wherein the slicing of the representation of the overhang structure includes non-planar slicing with respect to the slicing of the representation of the vertical portion.

The presently disclosed system and method of non-planar slicing and printing using additive manufacturing is more fully described in the detailed description below.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows a non-planar slicing and three-dimensional (3D) printing system in accordance with exemplary embodiments hereof;

FIG. 2 shows aspects of a build platform in accordance with exemplary embodiments hereof;

FIG. 3 shows aspects of an object to be 3D printed in accordance with exemplary embodiments hereof;

FIG. 4 shows aspects of a 3D printed object with support structures in accordance with exemplary embodiments hereof;

FIGS. 5-9 show aspects of an object being printed using a non-planar slicing and 3D printing system in accordance with exemplary embodiments hereof;

FIG. 10 shows aspects of an object being printed using a non-planar slicing and 3D printing system in accordance with exemplary embodiments hereof;

FIGS. 11-13 shows aspects of an object being printed using a non-planar slicing and 3D printing system in accordance with exemplary embodiments hereof; and

FIG. 14 depicts aspects of computing and computer devices in accordance with exemplary embodiments hereof.

### DETAILED DESCRIPTION OF EXEMPLARY EMBODIMENTS

In general, the system and method according to exemplary embodiments hereof includes a system and method of non-planar slicing and three-dimensional (3D) printing of objects with at least one overhang structure. In some embodiments, the system includes slicing software that performs non-planar slicing of the object's corresponding digital file, and control software that tilts the 3D printer's build platform in accordance with the non-planar slicing information.

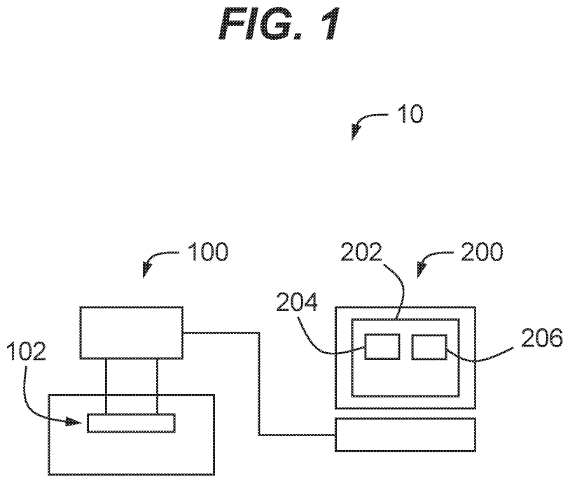

In some embodiments, as shown in FIG. 1, the system 10 includes an additive manufacturing system 100 (e.g., a three-dimensional (3D) printing system) and a controller 200 running software 202. The additive manufacturing system 100 may include a build platform 102 including a lower build surface 104 upon which objects may be printed. The system and method also may provide other functionalities as described herein.

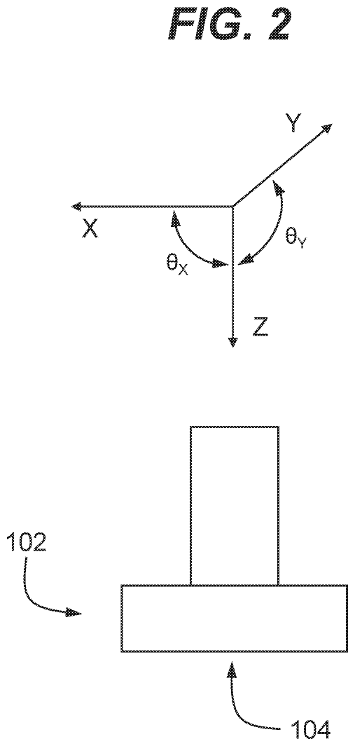

In some embodiments, as shown in FIG. 2, the build platform 102 and its build surface 104 may be controlled to move linearly along the Z-axis (e.g., up and down during the printing cycle) while being tilted to any angle θ_{X} in the X-plane and/or to any angle θ_{Y} in the Y-plane. In some embodiments, the build platform 102 may be tilted along a single axis (e.g., in the X-plane or in the Y-plane) and/or along multiple axes (e.g., in the X-plane and in the Y-plane simultaneously). It may be preferable that the build platform 102 be tiltable to any angle θ_{X} in the X-plane and to any angle θ_{Y} in the Y-plane simultaneously resulting in the tilting of the platform 102 to any angle in the combined X- and Y-planes.

In some embodiments, the system 10 includes software 202 running on the controller 200. The software 202 may include control software 204 that controls the movements and other aspects of the build platform 102, slicing software 206 that converts a three-dimensional model of the object to be 3D printed (e.g., a CAD model such as an STL file) into machine language (e.g., geometric code or “G-code”) that the 3D printer may recognize and use to print the object, and other types of software. The slicing software 206 may generally calculate and divide (slice) the digital object represented in the CAD file into a multitude of planar two-dimensional layers that the 3D printer may sequentially print one-at-a-time, bonding each new layer to the layer before it to form the three-dimensional object. Each layer is horizontal and planar with respect to each other layer (and with respect to the build surface 104) such that the layers are stacked on top of one another horizontally to form the three-dimensional object O.

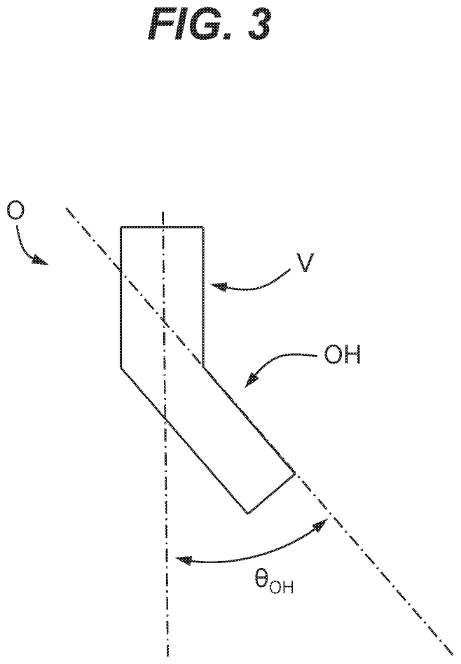

In some embodiments, the slicing software 206 also may analyze the overall structure of the three-dimensional object within the CAD file to identify any overhangs that the object may include. As is known in the art, an overhang is defined as an angle of inclination of the print wall from the vertical axis. For example, as shown in FIG. 3, an object O to be 3D printed may include a vertical portion V and an overhang portion OV that extends away from the vertical portion V at an overhang angle of inclination θ_{OH} with respect to vertical. During the 3D printing process of such an object O, if the overhang OV were to be printed without taking precautionary actions to support the overhang OH, the weight of the overhang OH may overcome the stiffness of the cured material, causing the overhang to deform, droop, and/or collapse.

As is known in the art, overhang criteria may be used to determine the need for support structures, and the criteria may depend on the type of additive manufacturing being performed by the system 10, the type of photosensitive resin being used to print the object (and its resulting stiffness), as well as other characteristics of the system 10 and/or of the object O. For example, for some types of additive manufacturing systems and/or resins, overhangs OH including overhang angles θ_{OH} greater than 19° may be deemed to require support structures. In other types of systems and/or with other types of resins, the overhang criteria may include overhang angles θ_{OH} of greater than 45°, and/or overhang lengths greater than 1.0 mm. It is understood that the system 10 may identify the proper overhang criteria to implement during its functioning, and that the scope of the system 10 is not limited in any way by the overhang criteria being implemented.

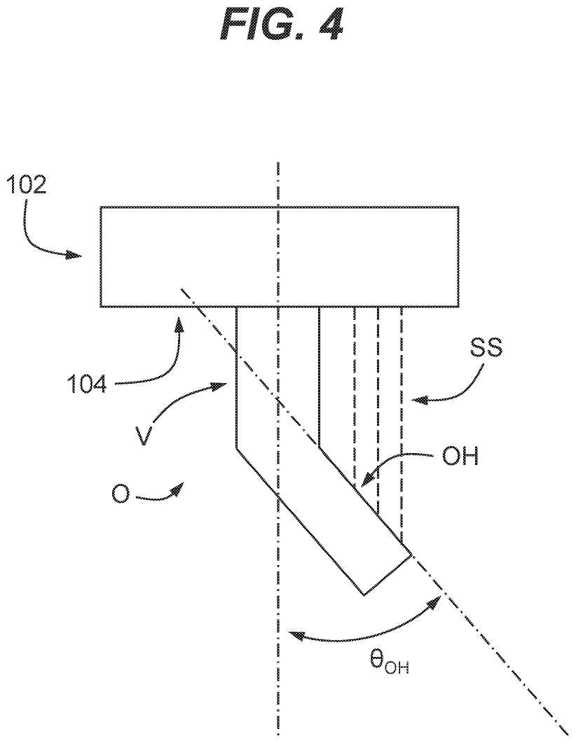

Customarily, as shown in FIG. 4, when an overhang OH extends at an angle greater than an overhang angle criteria, and/or is greater in length than an overhang length criteria, traditional slicing software may implement the addition and subsequent 3D printing of one or more support structures SS (depicted as dashed lines) to provide vertical support to the overhang structure OH. As shown, the support structures SS may generally extend from the overhang structure OH to the build surface 104 thereby providing vertical support to the overhang OH. Once the 3D printing of the object O is complete, the object O (including the support structures SS) may be removed from the print platform 102 and the support structures SS may be removed from the object O (e.g., by cutting).

While the 3D printing of the object O may benefit from the addition of the support structures SS, the support structures SS increase the amount of resin used to print the object O thereby increasing its overall cost. In addition, removal of the support structures SS oftentimes leaves surface marks on the object O that may or may not be removed via polishing.

In some embodiments, the slicing software 206 of the current invention may identify overhangs on the object O and may calculate a build platform tilt angle θ_{BP} that may eliminate and/or minimize the need for support structures.

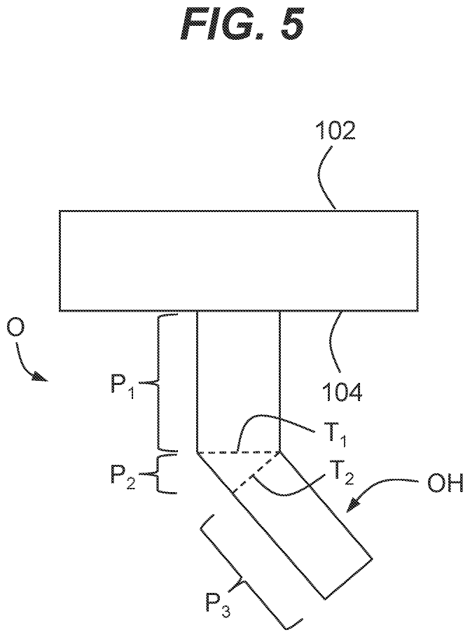

For example, in some embodiments, as shown in FIG. 5, using the object O of FIGS. 3 and 4 as an example, the slicing software 206 may identify the overhang OH, and may divide the object O into separate print portions P₁, P₂, P₃ . . . Pₙ. The print portions Pₙ may include first portions of the object O that may not include an overhang, second portions of the object O that may include an overhang, and transitional portions of the object O between the first portions and the second portions.

Using the example object O of FIG. 4, in some embodiments as shown in FIG. 5, the slicing software 206 may identify the vertical print portion P₁, a transition print portion P₂, and the overhang print portion P₃. Once the print portions are identified, the slicing software 206 may perform the slicing of the object (e.g., using the CAD file) in preparation for the object O to be 3D printed.

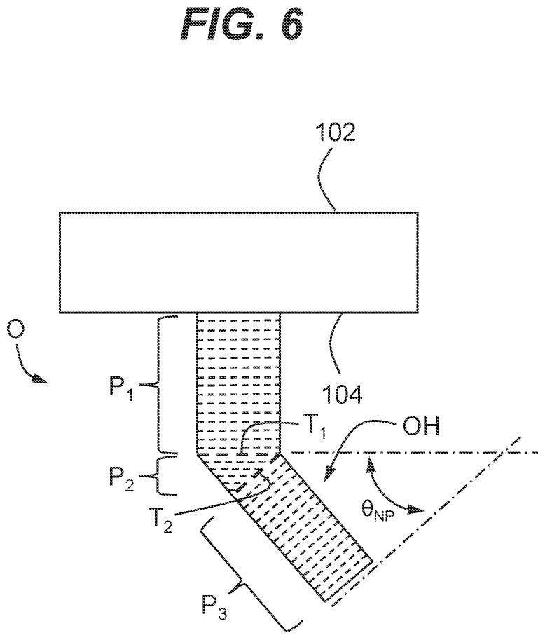

In some embodiments, as shown in FIG. 6, the slicing may include horizontal slicing (e.g., in the areas of the vertical print portion P₁ and the transition print portion P₂) as well as non-horizontal slicing (e.g., in the area of the overhang print portion P₃). The resulting example individual slices are depicted as dashed lines. As shown, the slices in the areas of P₁ and P₂ may be planar with respect to one another, and the slices in the area of P₃ also may be planar with respect to one another. However, the slices in the area of P₃ may not be planar (i.e., non-planar) with respect to the slices in the areas of P₁ and P₂. Instead, the slices in the area of P₃ may be at an offset angle θ_{NP} with respect to the horizontal. In this example, and in some embodiments, the absolute value of the P₃ slice offset angle θ_{NP} may equal the absolute value of the overhang angle θ_{OH} (see FIG. 4).

In some embodiments, as shown in FIGS. 5 and 6, the transition print portion P₂ may include a first transition layer T₁ at the interface between itself and vertical print portion P₁, and a second transition layer T₂ at the interface between itself and the overhang print portion P₃. The first transition layer T₁ may be horizontal and the second transition layer T₂ may be at the offset angle θ_{NP}. As will be described below, the system 10 may tilt the print platform 102 prior to printing the second transition layer T₂.

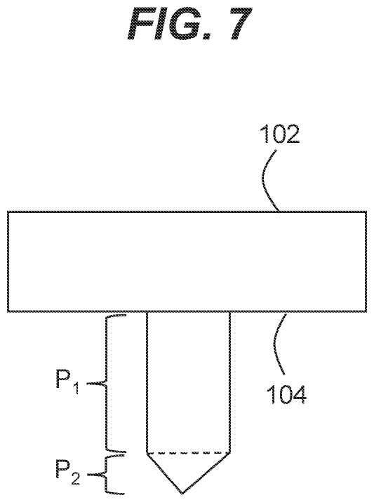

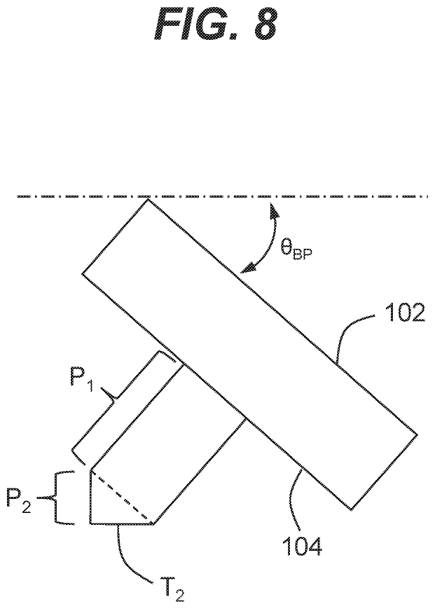

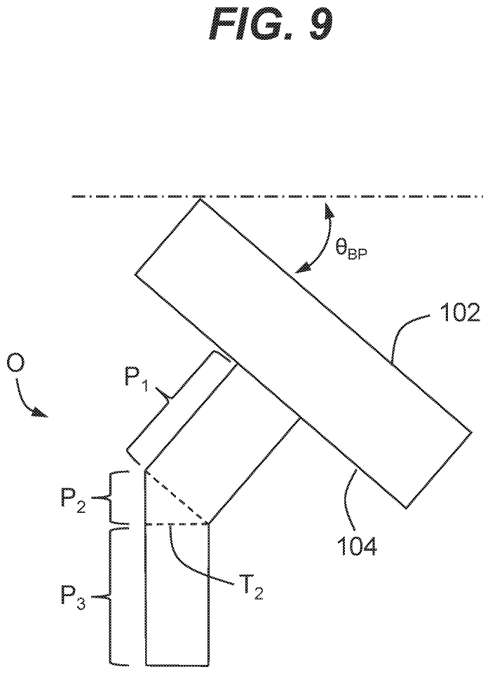

In some embodiments, as shown in FIGS. 7-9, after and/or in parallel with the slicing process, the system 10 may perform the 3D printing of the object O. In some embodiments, as shown in FIG. 7, the system 10 may utilize the slicing data determined by the slicing software 206 to print the object's first and second print portions P₁, P₂. Once portions P₁ and P₂ are built, the system 10 may tilt the print platform 102 (and the print surface 104) to the build platform tilt angle θ_{BP} (which may equal the offset angle θ_{NP}) to reorient the second transition layer T₂ to the horizontal. In this way, the second transition layer T₂ may be printed. The result of the printing process is shown in FIG. 9 and the object O may be removed from the print surface 104 for post processing. Notably, because the system 10 eliminated the need for support structures as described above, the post processing does not require the removal of any support structures and/or the polishing of support structure surface marks.

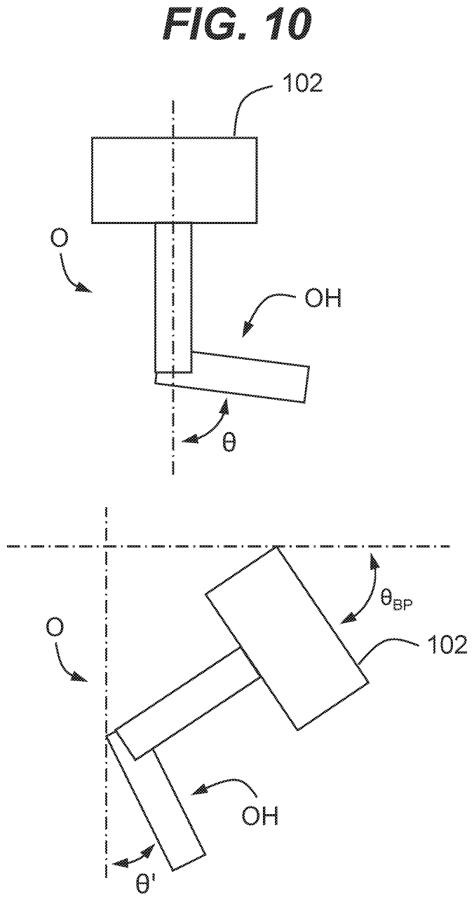

In some embodiments, it may not be required that the overhang portion P₃ be oriented perfectly vertical for the printing process. For example, it may be adequate that the print platform 102 be tilted at a tilt angle θ_{BP} such that the overhang angle θ_{OH} of the overhang structure OH is simply less than the overhang criteria angle. In this way, with the platform 102 tilted, the overhang structure OH may not be deemed to require support structures during the printing process. An example of this is shown in FIG. 10 with the initial overhang angle θ being greater than the overhang criteria angle, and the overhang angle θ′ after the tilting of the platform 102 being less than the overhang criteria angle. In this example, even though the tilted overhang structure OH is not completely vertical, the tilted overhang OH with overhang angle θ′ may be 3D printed using the system 10 and the associated methodology described herein without requiring the addition of support structures.

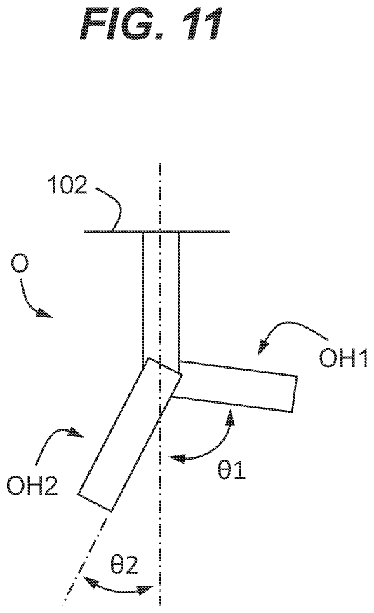

In some embodiments, as shown in FIG. 11, the system 10 may analyze an object O to be printed that includes two or more overhang structures. In some embodiments, the system 10 may perform at least some of the following actions:
1. Determine tilt angle(s) for the build platform 102 that may place the two or more overhang structures at angles below the overhang criteria such that the overhang structures do not require support structures.
2. In cases where a single tilt angle may not place all of the overhang structures below the overhang criteria simultaneously, the system 10 may determine overhang tilt angle(s) that may place the highest number of overhang structures below the criteria.
3. The system 10 also may analyze the number, size, and locations of potential support structures for each of the overhangs and may determine tilt angle(s) to minimize the number and size of the potential support structures collectively.
4. The system 10 may place weight factors on each of the potential support structures for each of the overhang structures (e.g., based on the number, size, and location of the support structures), and may rank or prioritize the elimination and/or the reduction of the potential support structures with the highest weight factors. For example, the system 10 may determine which potential support structures would require the most amount of resin and/or cause the most surface marks and may determine tilt angle(s) to eliminate and/or minimize these support structures in particular. In this case, lesser weighted support structures may be required if necessary.
5. The system 10 may determine compromise tilt angle(s) that may accommodate the highest number of overhang structures simultaneously.
6. The system 10 at any time may present its analysis to the user and allow the user to decide which actions the system 10 should take (e.g., which support structures should be prioritized for removal and/or minimization, which support structures should be allowed to remain, etc.)

By performing at least some of the actions described above, the system 10 may reduce the number of required support structures, may reduce the size of the support structures, may optimize the location(s) of the support structures, may consolidate two or more support structures into a single support structure, and/or may generally optimize the printing of the object O to minimize the negative impact(s) of the potential support structures during the printing process.

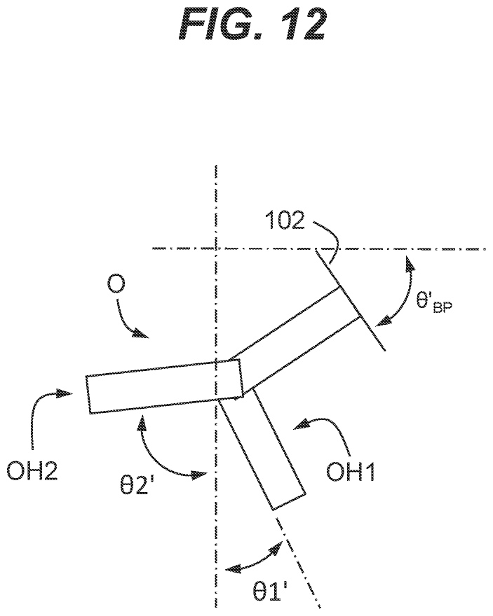

In a first example, as shown in FIG. 11, an object O may include a first overhang structure OH1 at a first overhang angle of θ1 and a second overhang structure OH2 at a second overhang angle of θ2. The system 10 may determine that the first overhang angle θ1 is greater than the overhang angle criteria, and that tilting of the build platform 102 may be required to eliminate the need for a support structure for OH1. As such, as shown in FIG. 12, the system 10 may determine a tilt angle θ′_{BP} that reduces the overhang angle θ1 to a lesser angle θ1′ below the criteria.

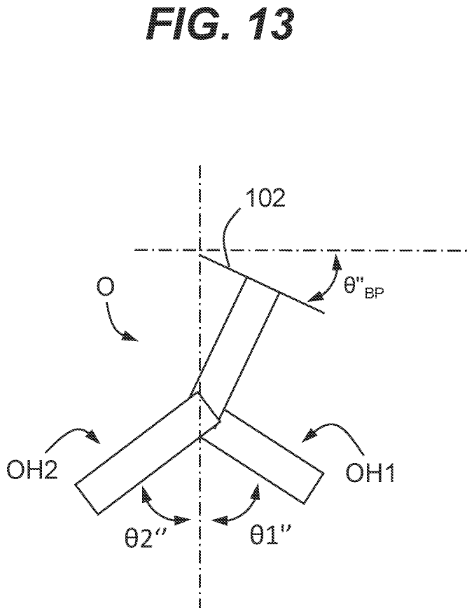

Expanding on this example, the system 10 may then determine that tilting the build platform 102 to the tilt angle θ′_{BP} increases the second overhang's angle θ2 to above the overhang angle criteria, thereby causing the second overhang OH2 to require a support structure. Accordingly, as shown in FIG. 13, the system 10 may then determine a compromise tilt angle θ′_{BP} that reduces both overhang angles θ1, θ2 to each be below the criteria such that neither of the overhangs OH1, OH2 require support structures.

It is understood that while the examples shown in the figures and described herein primarily include two-dimensional depictions of the build platform 102 and the object O being printed, as well as depictions of the build platform 102 being tilted along a single plane, the system 10 may tilt the build platform 102 along any combinations of planes in three-dimensional space. It also is understood that the system 10 may tilt the build platform 102 during any cycle of the 3D printing process.

It is understood that any aspect or element of any embodiment described herein may be combined with any other aspect or element of any other embodiment to form additional embodiments of the system 10, all of which are within the scope of the system 10.

Computing

The services, mechanisms, operations, and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

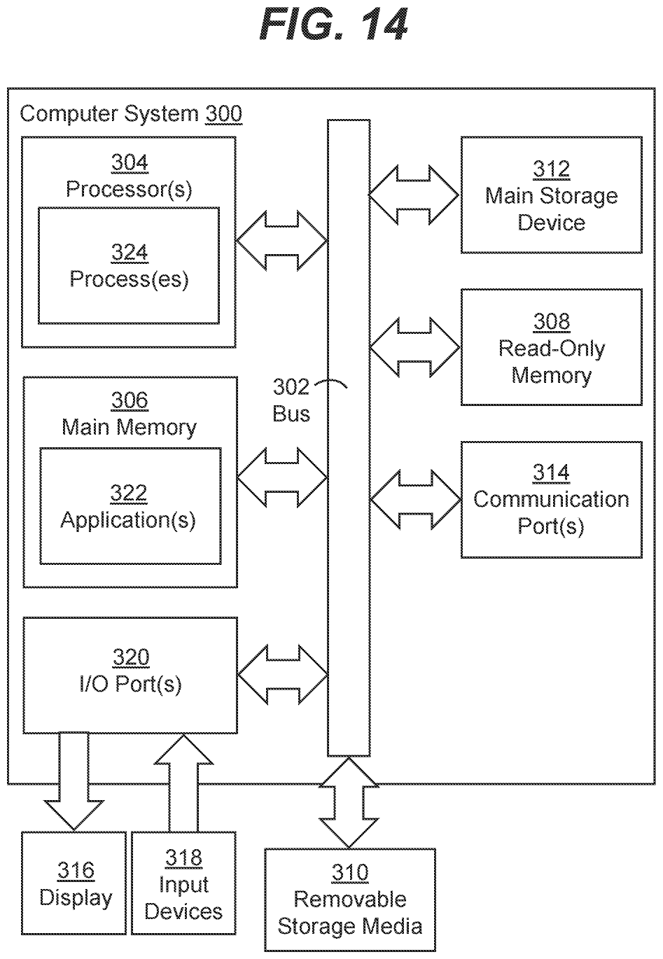

FIG. 14 is a schematic diagram of a computer system 300 upon which embodiments of the present disclosure may be implemented and carried out.

According to the present example, the computer system 300 includes a bus 302 (i.e., interconnect), one or more processors 304, one or more communications ports 314, a main memory 310, removable storage media 310, read-only memory 308, and a mass storage 312. Communication port(s) 314 may be connected to one or more networks by way of which the computer system 300 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 304 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 314 can be any of an RS-232 port for use with a modem-based dial-up connection, a 10/100 Ethernet port, a Gigabit port using copper or fiber, or a USB port, and the like. Communications port(s) 314 may be chosen depending on a network such as a Local Area Network (LAN), a Wide Area Network (WAN), a CDN, or any network to which the computer system 1600 connects. The computer system 300 may be in communication with peripheral devices (e.g., display screen 310, input device(s) 318) via Input/Output (I/O) port 320. Some or all of the peripheral devices may be integrated into the computer system 300, and the input device(s) 318 may be integrated into the display screen 310 (e.g., in the case of a touch screen).

Main memory 310 can be Random Access Memory (RAM), or any other dynamic storage device(s) commonly known in the art. Read-only memory 308 can be any static storage device(s) such as Programmable Read-Only Memory (PROM) chips for storing static information such as instructions for processor(s) 304. Mass storage 312 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 202 communicatively couples processor(s) 304 with the other memory, storage and communications blocks. Bus 302 can be a PCI/PCI-X, SCSI, a Universal Serial Bus (USB) based system bus (or other) depending on the storage devices used, and the like. Removable storage media 310 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor, or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 310 is encoded with application(s) 322 that support(s) the functionality as discussed herein (an application 322 may be an application that provides some or all of the functionality of one or more of the mechanisms described herein). Application(s) 322 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 304 accesses main memory 310 via the use of bus 302 in order to launch, run, execute, interpret or otherwise perform the logic instructions of the application(s) 322. Execution of application(s) 322 produces processing functionality of the service(s) or mechanism(s) related to the application(s). In other words, the process(es) 324 represents one or more portions of the application(s) 322 performing within or upon the processor(s) 304 in the computer system 300.

It should be noted that, in addition to the process(es) 324 that carries(carry) out operations as discussed herein, other embodiments herein include the application 322 itself (i.e., the un-executed or non-performing logic instructions and/or data). The application 322 may be stored on a computer readable medium (e.g., a repository) such as a disk or in an optical medium. According to other embodiments, the application 322 can also be stored in a memory type system such as in firmware, read only memory (ROM), or, as in this example, as executable code within the main memory 310 (e.g., within Random Access Memory or RAM). For example, application 322 may also be stored in removable storage media 310, read-only memory 308, and/or mass storage device 312.

Those skilled in the art will understand that the computer system 300 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of three-dimensional (3D) printing an object on a build platform, the object including an overhang structure, the method comprising:
receiving a digital file including a representation of the object including a representation of the overhang structure;
determining, by one or more computer systems, an angle of inclination of the representation of the overhang structure;
determining a build platform tilt angle to reduce the angle of inclination to below an overhang angle threshold;
tilting the build platform to the build platform tilt angle; and
3D printing the overhang structure.

2. The method of claim 1 further comprising:
slicing, by one or more computer systems, the representation of the overhang structure.

3. The method of claim 2 wherein the slicing of the representation of the overhang structure includes non-planar slicing.

4. The method of claim 1 wherein the object includes a vertical portion and the overhang structure, the method further comprising:
slicing, by one or more computer systems, a representation of the vertical portion within the digital file and the representation of the overhang structure;
wherein the slicing of the representation of the overhang structure includes non-planar slicing with respect to the slicing of the representation of the vertical portion.

5. The method of claim 3 wherein an angle of the non-planar slicing is based at least in part on the angle of inclination of the representation of the overhang structure.

6. The method of claim 5 wherein an absolute value of the angle of the non-planar slicing is substantially equal to an absolute value of the angle of inclination of the representation of the overhang structure.

7. The method of claim 1 wherein the build platform tilt angle is based at least in part on the angle of inclination of the representation of the overhang structure.

8. The method of claim 1 wherein an absolute value of the build platform tilt angle is substantially equal to an absolute value of angle of the inclination of the representation of the overhang structure.

9. A method of three-dimensional (3D) printing an object on a build platform, the object including a vertical portion with an overhang structure, the method comprising:
receiving a digital file including a representation of the object including a representation of the vertical portion and of the overhang structure;
determining, by one or more computer systems, an angle of inclination of the representation of the overhang structure;
determining, by one or more computer systems, if the angle of inclination of the representation of the overhang structure is greater than an overhang angle threshold;
in response to a determination that the representation of the overhang structure is greater than the overhang angle threshold, then;
determining a build platform tilt angle to reduce the angle of inclination of the overhang structure to below the overhang angle threshold;
3D printing the vertical portion;
tilting the build platform to the build platform tilt angle; and
3D printing the overhang structure.

10. The method of claim 9 further comprising:
slicing, by one or more computer systems, the representation of the vertical portion and the representation of the overhang structure;
wherein the slicing of the representation of the overhang structure includes non-planar slicing with respect to the slicing of the representation of the vertical portion.

11. The method of claim 10 wherein an angle of the non-planar slicing is based at least in part on the angle of inclination of the representation of the overhang structure.

12. The method of claim 10 wherein an absolute value of the angle of the non-planar slicing is substantially equal to an absolute value of the angle of inclination of the representation of the overhang structure.

13. The method of claim 9 wherein the build platform tilt angle is based at least in part on the angle of inclination of the representation of the overhang structure.

14. The method of claim 9 wherein an absolute value of the build platform tilt angle is substantially equal to an absolute value of angle of the inclination of the representation of the overhang structure.
